(19) United States
(12) Patent Application Publication
(10) Pub. No.: US 2025/0106778 A1
(43) Pub. Date: Mar. 27, 2025

(54) CLOSED LOOP POWER CONTROL FOR PUSCH AND PUCCH TRANSMISSION IN MULTI-TRP

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN); Lingling XIAO, Beijing (CN)

(21) Appl. No.: 18/290,986

(22) PCT Filed: Jul. 23, 2021
(86) PCT No.: PCT/CN2021/108130

§ 371 Date: Jan. 22, 2024

(51) Int. Cl. H04W 52/08; H04W 52/14; H04W 52/42

(52) U.S. Cl. CPC H04W 52/08; H04W 52/146; H04W 52/42

(57) ABSTRACT

Methods and apparatuses for closed loop power control for PUSCH and PUCCH transmissions in multi-TRP scenario are disclosed. A method at an UE comprises receiving one or multiple DCIs, each DCI includes a first TPC field and a second TPC field and schedules one or multiple PUSCH or PUCCH transmissions; determining mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI; calculating closed loop power adjustment for each of the scheduled PUSCH or PUCCH transmissions according to the received TPC command(s) between each of the scheduled PUSCH or PUCCH transmissions and its scheduling DCI and the mappings; and transmitting each of the scheduled PUSCH or PUCCH transmissions with a power based on its calculated closed loop power adjustment.

### FIELD

The subject matter disclosed herein generally relates to wireless communications, and more particularly relates to methods and apparatuses for closed loop power control for PUSCH and PUCCH transmissions in multi-TRP scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Transmission Power Command (TPC), Downlink control information (DCI), Transmission Reference Point (TRP), Physical Uplink Shared Channel (PUSCH), Physical Uplink Control Channel (PUCCH), frequency range 2 (FR2): corresponding to 24.25˜GHz52.6 GHz, band width part (BWP), Information Element (IE), Automatic Repeat-reQuest (ARQ), Hybrid ARQ (HARQ), Acknowledgement (ACK), Physical Downlink Shared Channel (PDSCH), Physical Downlink Control Channel (PDCCH).

In NR Release 15 and Release 16, closed loop power control for PUSCH and PUCCH transmissions in single-TRP scenario is supported. A TPC (Transmission Power Command) can be included in a TPC field of the DCI scheduling PUSCH or PUCCH transmission to determine the closed loop power adjustment for the scheduled PUSCH or PUCCH transmission. The UE adjusts the transmit power for the scheduled PUSCH or PUCCH transmission according to the TPC command included in the scheduling DCI. Up to two different closed power control loops, where each loop has a closed loop index 1, can be maintained for a UE for PUSCH or PUCCH transmissions. Each PUSCH or PUCCH transmission is transmitted with a certain closed loop index value.

In NR Release 17, PUSCH and PUCCH transmissions with repetition in multi-TRP scenario are supported. The gNB sends a DCI scheduling a PUSCH or a PUCCH transmission with repetition targeting different TRPs (e.g. two TRPs). A PUSCH or a PUCCH transmission with repetition (e.g. with multiple repetitions) refers to multiple PUSCH or PUCCH transmissions, each of which is a repetition of the first PUSCH or PUCCH transmission. Each repetition of the PUSCH or the PUCCH transmission is transmitted with different TX beams (e.g. two TX beams) targeting the different TRPs (e.g. the two TRPs). As shown in FIG. 1, a DCI transmitted on a DL channel schedules a PUSCH transmission on an UL channel with multiple repetitions targeting different TRPs (e.g. two TRPs). The n^{th} repetition of the PUSCH transmission is denoted as PUSCH-n. As shown in FIG. 1, n takes a value from 1 to 4, representing 4 repetitions: PUSCH-1, PUSCH-2, PUSCH-3, PUSCH-4; with PUSCH-1 and PUSCH-3 transmitted using one TX beam to one TRP, while PUSCH-2 and PUSCH-4 transmitted using another beam to another TRP. If different closed power control loops are indicated for PUSCH or PUCCH transmissions (repetitions) transmitted to different TRPs, independent TPC commands for different loops are expected to be indicated in the scheduling DCI.

It has been agreed that a second TPC field can be configured to be included in the scheduling DCI to support per TRP closed-loop power control for PUCCH and PUSCH transmission with repetition. However, the UE behaviors for different transmission cases are unknown.

This invention targets specifying UE behaviors when a DCI containing multiple TPC fields schedules a PUSCH or PUCCH transmission with repetition.

### BRIEF SUMMARY

Methods and apparatuses for closed loop power control for PUSCH and PUCCH transmissions in multi-TRP scenario are disclosed.

In one embodiment, a method at an UE comprises receiving one or multiple DCIs, each DCI includes a first TPC field and a second TPC field and schedules one or multiple PUSCH or PUCCH transmissions; determining mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI; calculating closed loop power adjustment for each of the scheduled PUSCH or PUCCH transmissions according to the received TPC command(s) between each of the scheduled PUSCH or PUCCH transmissions and its scheduling DCI and the mappings; and transmitting each of the scheduled PUSCH or PUCCH transmissions with a power based on its calculated closed loop power adjustment. The method may further comprise receiving a RRC signaling to configure that the second TPC field is included in the DCI format 0_1 or 0_2, when two SRS resource sets, both of which are used for either codebook or non-codebook based PUSCH transmission, are configured in a BWP and two PUSCH power control adjustment states are configured and the UE indicates a capability to support two TPC fields in DCI format 0_1 or 0_2 for scheduling PUSCH transmissions, and/or receiving a RRC signaling to configure that the second TCP field is indicated in the DCI format 1_1 or 1_2, when at least one PUCCH resource is activated with more than one PUCCH-SpatialRelationInfo and two PUCCH power control adjustment states are configured and the UE indicates a capability to support two TPC fields in DCI format 1_1 or 1_2 for scheduling PUCCH transmissions.

For codebook based PUSCH transmission, the gNB shall indicate a transmit precoding matrix index to select a precoding matrix from a pre-defined codebook to apply to the scheduled PUSCH transmission. The gNB shall select the precoding matrix based on the SRS resources transmitted by the UE, where a SRS (sounding reference signal) is a dedicated UL signal used for UL channel estimation. For non-codebook based PUSCH transmission, the UE shall first transmit multiple SRS resources with different precoding matrices calculated by the UE. The gNB shall indicate one or more SRS resources to the UE for the scheduled PUSCH transmission, and the UE shall apply the same precoding matrix to the scheduled PUSCH transmission as the SRS resources indicated by the gNB.

In one embodiment, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1. If only one PUCCH-SpatialRelationInfo is activated for the scheduled PUCCH transmission or a same closed loop index is indicated by the two PUCCH-SpatialRelationInfos activated for the scheduled PUCCH transmissions, or if only one PUSCH transmission is scheduled or the scheduled multiple PUSCH transmissions are indicated with a same closed loop index, the TPC command indicated by one of the first TPC field and the second TPC field that has the same closed loop index as that indicated to the scheduled PUCCH or PUSCH transmission(s) is applied to the scheduled PUCCH or PUSCH transmission(s), and the TPC command indicated by the other of the first TPC field and the second TPC field is ignored.

In another embodiment, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo. When a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmission(s) with the ClosedLoopIndex value indicated by the PUCCH-SpatialRelationInfo(s) activated for the PUCCH transmissions, and the TPC command indicated by the second TPC field is ignored. When different ClosedLoopIndex values are indicated by the sri-PUSCH-PowerControl (which is used to configure a set of power control parameters for PUSCH transmission using sounding reference signal (SRS) resource(s) indicated by the SRI field and each sri-PUSCH-PowerControl is mapped to a SRI field value) values that are mapped to values of a first SRI field and a second SRI field included in a DCI format 0_1 or 0_2, the TPC command indicated by the first TPC field of the DCI applies to the PUSCH transmission(s) with the ClosedLoopIndex value indicated by the first SRI field, and the TPC command indicated by the second TPC field applies to the PUSCH transmission(s) with the ClosedLoopIndex value indicated by the second SRI field. When a same ClosedLoopIndex value is indicated by sri-PUSCH-PowerControl values that are mapped to values of a first SRI field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

In still another embodiment, the ignored TPC command(s) are not included in calculating the closed loop power adjustment. Alternatively, the ignored TPC command(s) are included in calculating the closed loop power adjustment.

In one embodiment, a method at a base unit comprises transmitting one or multiple DCIs, each DCI includes a first TPC field and a second TPC field and schedules one or multiple PUSCH or PUCCH transmissions; determining mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI; calculating closed loop power adjustment for each of the scheduled PUSCH or PUCCH transmissions according to the received TPC command(s) between each of the scheduled PUSCH or PUCCH transmissions and its scheduling DCI and the mappings; and receiving each of the scheduled PUSCH or PUCCH transmissions with a power based on its calculated closed loop power adjustment.

In another embodiment, a remote unit (UE) comprises a receiver that receives one or multiple DCIs, each DCI includes a first TPC field and a second TPC field and schedules one or multiple PUSCH or PUCCH transmissions; a processor that determines mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI, and calculates closed loop power adjustment for each of the scheduled PUSCH or PUCCH transmissions according to the received TPC command(s) between each of the scheduled PUSCH or PUCCH transmissions and its scheduling DCI and the mappings; and a transmitter that transmits each of the scheduled PUSCH or PUCCH transmissions with a power based on its calculated closed loop power adjustment.

In yet another embodiment, a base unit comprises a transmitter that transmits one or multiple DCIs, each DCI includes a first TPC field and a second TPC field and schedules one or multiple PUSCH or PUCCH transmissions; a processor that determines mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI, and calculates closed loop power adjustment for each of the scheduled PUSCH or PUCCH transmissions according to the received TPC command(s) between each of the scheduled PUSCH or PUCCH transmissions and its scheduling DCI and the mappings; and a receiver that receives each of the scheduled PUSCH or PUCCH transmissions with a power based on its calculated closed loop power adjustment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of one DCI scheduling a PUSCH transmission with 4 repetitions;

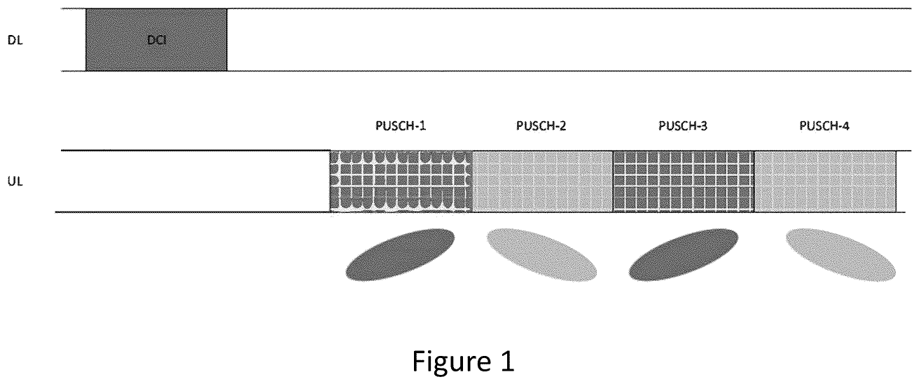

FIG. 2 illustrates an example of the first sub-embodiment of the second embodiment;

FIG. 3 illustrates another example of the first sub-embodiment of the second embodiment;

FIG. 4 illustrates a prior art example of closed loop power adjustment;

FIG. 5 illustrates an example of the first sub-embodiment of the third embodiment;

FIG. 6 illustrates an example of the second sub-embodiment of the third embodiment;

FIG. 7 illustrates another example of the second sub-embodiment of the third embodiment;

FIG. 8 is a schematic flow chart diagram illustrating an embodiment of a method;

FIG. 9 is a schematic flow chart diagram illustrating a further embodiment of a method; and

FIG. 10 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate an architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

It has been agreed to support per TRP closed-loop power control for PUSCH or PUCCH transmission by configuring a second TPC field in a scheduling DCI.

A first embodiment relates to when two TPC commands (i.e. a second TPC field in addition to a first TPC field) are contained in the scheduling DCI.

A first sub-embodiment of the first embodiment relates to when two TPC commands are contained in the DCI scheduling PUSCH transmissions (e.g. a PUSCH transmission with repetition).

In a single-TRP scenario supported in NR Releases 15 and 16, one TPC field is included within DCI format 0_1 or 0_2 for scheduling a PUSCH transmission since the scheduled PUSCH transmission is to be transmitted to only one TRP with a single TX beam in FR2. In a multi-TRP scenario supported in NR Release 17, a DCI format 0_1 or 0_2 may further be used to schedule a PUSCH transmission with repetitions, where each repetition targets different TRPs (e.g. two TRPs) using different TX beams (e.g. two TX beams). Two SRS resource sets, both of which are configured with usage of either ‘codebook’ or ‘non-codebook’, are configured to support the PUSCH transmission with repetitions targeting two TRPs in an activated BWP of a serving cell, where each of the two SRS resource sets is associated with a different TRP of the two TRPs.

A second TPC field can be configured to be included in the scheduling DCI for multi-TRP PUSCH repetitions if two PUSCH power control adjustment states, i.e., two closed loops for a PUSCH power control, are configured to support per TRP closed-loop power control for PUSCH transmission (i.e. the PUSCH transmission transmitted to different TRPs may be associated with different closed loops). In addition, it is necessary that the UE indicates a capability to support two TPC fields in DCI format 0_1 or 0_2.

Therefore, according to the first sub-embodiment of the first embodiment, when the UE is configured with two PUSCH power control adjustment states by configuring an RRC parameter twoPUSCH-PC-AdjustmentStates in a PUSCH-PowerControl IE (the PUSCH-PowerControl IE is used to configure the power control related parameters for PUSCH transmission), and is configured with two or more SRS resource sets with usage of either ‘codebook’ or ‘non-codebook’ in the active BWP of the serving cell, the gNB configures a second TPC field in DCI format 0_1 or 0_2 if the UE indicates the capability to support two TPC fields in DCI format 0_1 or 0_2.

A second sub-embodiment of the first embodiment relates to when two TPC commands are configured in the DCI scheduling PUCCH transmissions (e.g. a PUCCH transmission with repetition).

In NR Releases 15 and 16, one TPC field for indicating TPC command is included in DCI format 1_1 or 1_2 for scheduling a PUCCH transmission to report a HARQ-ACK for the scheduled PDSCH transmission. The triggered PUCCH resource is only transmitted to one TRP with a single TX beam. That is, the scheduled PUCCH transmission corresponds to the triggered PUCCH resource indicated by the PUCCH resource indicator field contained in the scheduling DCI format 1_1 or 1_2. In multi-TRP scenario of NR Release 17, one PUCCH resource may be activated with more than one PUCCH-SpatialRelationInfo to configure multiple TX beams for multi-TRP based PUCCH repetition for higher reliability, where the triggered PUCCH resource is transmitted to different TRPs (e.g. two TRPs) using different TX beams (e.g. two TX beams) in different time slots by multiple PUCCH transmissions. That is, each PUCCH transmission corresponds to one repetition of the PUCCH resource indicated by the PUCCH resource indicator field contained in the scheduling DCI 1_1 or 1_2.

A second TPC field can be configured to be included in the scheduling DCI for multi-TRP PUCCH repetition if two PUCCH power control adjustment states, i.e., two closed loops for PUCCH power control, are configured to support per TRP closed-loop power control for PUCCH transmissions (i.e. the PUCCH transmission transmitted to different TRPs may be associated with different closed loops). In addition, it is necessary that UE indicates a capability to support two TPC fields in DCI format 1_1 or 1_2.

Therefore, according to the second sub-embodiment of the first embodiment, when the UE is configured with two PUCCH power control adjustment states by configuring the RRC parameter twoPUCCH-PC-AdjustmentStates in a PUCCH-PowerControl IE, and at least one PUCCH resource is activated with more than one PUCCH-SpatialRelationInfo value, the gNB configures a second TPC field in DCI format 1_1 or 1_2 if the UE indicates the capability to support two TPC fields in DCI format 1_1 or 1_2.

A second embodiment relates to the mapping between multiple TPC commands and PUSCH or PUCCH transmissions. For example, in the mapping, one TPC command is associated with several PUSCH or PUCCH transmissions while the other TPC command is associated with several other PUSCH or PUCCH transmissions. Each PUSCH or PUCCH transmission has a closed loop index. So, the mapping between the multiple TPC commands and the PUSCH or PUCCH transmissions can be implemented as a mapping between the multiple TPC commands and the closed loop indices. For example, in the mapping, one TPC command is associated with one closed loop index while the other TPC command is associated with the other closed loop index.

When a second TPC field is included in DCI format 0_1 or 0_2 for PUSCH transmissions or included in DCI format 1_1 or 1_2 for PUCCH transmissions, two TPC fields (a first TPC field and the second TPC field) are included in the DCI. The mapping between the two TPC commands indicated respectively by the two TPC fields of a DCI and the PUCCH or PUSCH transmissions (or the closed loop indices of the PUCCH or PUSCH transmissions) scheduled by the DCI can be determined with different methods.

According to a first sub-embodiment of the second embodiment, a fixed mapping method is adopted.

According to the first sub-embodiment of the second embodiment (i.e. the fixed mapping method), the first TPC field indicates the TPC command for the PUSCH or PUCCH transmission(s) (or repetitions) with closed loop index l=0; and the second TPC field indicates the TPC command for the PUSCH or PUCCH transmission(s) (or repetitions) with closed loop index l=1.

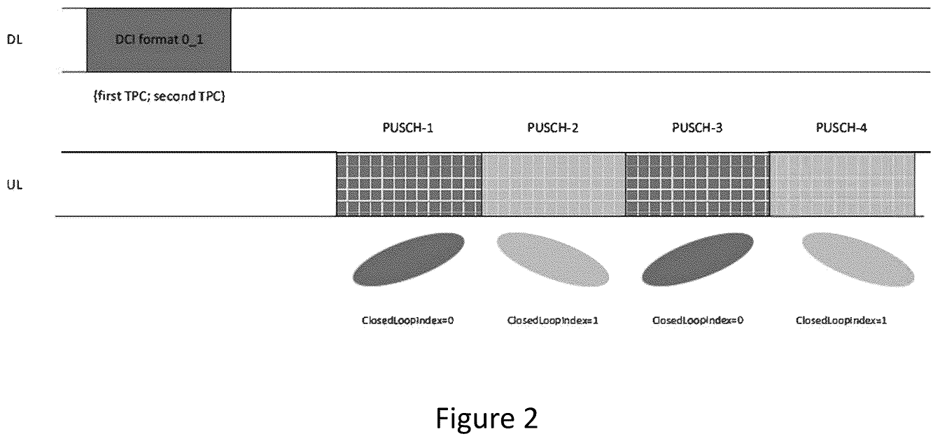

FIG. 2 illustrates an example of the first sub-embodiment of the second embodiment.

As shown in FIG. 2, a single DCI format 0_1 transmitted on a Downlink channel including two TPC fields (e.g. a first TPC field and a second TPC field) schedules a PUSCH transmission with 4 repetitions (e.g. 4 PUSCH transmissions, where n is from 1 to 4). These 4 repetitions of the scheduled PUSCH transmission are to be transmitted with two different TX beams. For example, as shown in FIG. 2, PUSCH-1 and PUSCH-3 repetitions are transmitted with the same TX beam as indicated by a ClosedLoopIndex l=0, and PUSCH-2 and PUSCH-4 repetitions are transmitted with another same TX beam as indicated with a ClosedLoopIndex l=1. UE shall apply the TPC command indicated by the first TPC field received to PUSCH-1 and PUSCH-3 repetitions of the PUSCH transmission and apply the TPC command indicated by the second TPC field to PUSCH-2 and PUSCH-4 repetitions of PUSCH transmission.

When two TPC fields are included in the scheduling DCI format 0_1 or 0_2, if only one PUSCH transmission (e.g. without repetition) is scheduled to be transmitted with one TX beam to one TRP, UE only applies the TPC command indicated by one of the first TPC field and the second TPC field received in the DCI format 0_1 or 0_2, with the associated closed loop index as that indicated by the SRI field(s) in the DCI format 0_1 or 0_2. For example, the TPC command indicated by the first TPC field is associated with ClosedLoopIndex l=0; and the TPC command indicated by the second TPC field is associated with ClosedLoopIndex l=1. The other one of the first TPC field and the second TPC field, that is associated with a different closed loop index from that indicated by the SRI field(s) in the DCI format 0_1 or 0_2 should be ignored.

In another situation, when two TPC fields are included in the scheduling DCI format 0_1 or 0_2, and a same closed loop index is indicated for the multiple PUSCH transmissions (or repetitions) by the SRI field(s) in the DCI format 0_1 or 0_2, the UE only applies the TPC command indicated by the TPC field (one of the first TPC field and the second TPC field) in the DCI format 0_1 or 0_2 with the same closed loop index as that indicated by the SRI field(s) in the DCI format 0_1 or 0_2. The other one of the first TPC field and the second TPC field, that is associated with a different closed loop index from that indicated by the SRI field(s) in the DCI format 0_1 or 0_2 should be ignored.

When two TPC fields are included in the scheduling DCI format 1_1 or 1_2, if the scheduled PUCCH resource is only activated with one PUCCH-SpatialRelationInfo, the UE only applies the TPC command indicated by the TPC field (one of the first TPC field and the second TPC field) in DCI format 1_1 or 1_2 with the same closed loop index as that indicated by the activated PUCCH-SpatialRelationInfo. The other one of the first TPC field and the second TPC field, that is associated with a different closed loop index from that indicated by the activated PUCCH-SpatialRelationInfo should be ignored.

In another situation, when two TPC fields are included in the scheduling DCI format 1_1 or 1_2, if the scheduled PUCCH resource is activated with more than one PUCCH-SpatialRelationInfo but the same closed loop index is configured for each activated PUCCH-SpatialRelationInfo, the UE only applies the TPC command indicated by the TPC field (one of the first TPC field and the second TPC field) in DCI format 1_1 or 1_2 with the same closed loop index as that indicated by each activated PUCCH-SpatialRelationInfo. The other one of the first TPC field and the second TPC field, that is associated with a different closed loop index from that indicated by the activated PUCCH-SpatialRelationInfo should be ignored.

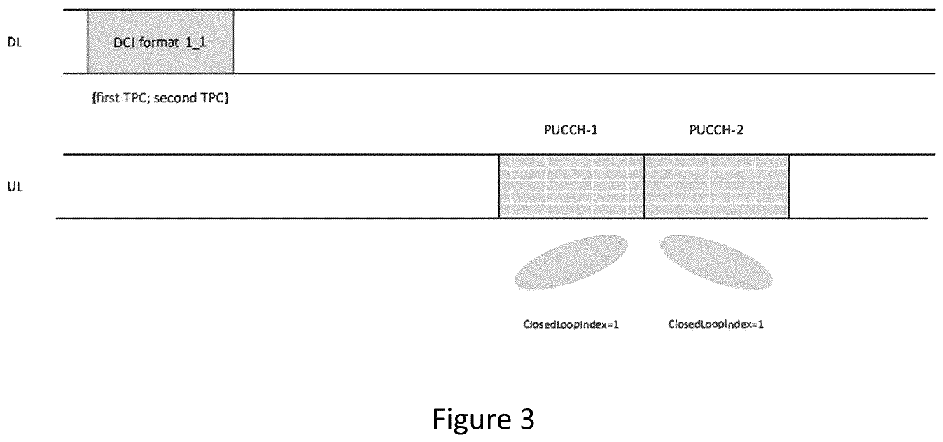

FIG. 3 illustrates another example of the first sub-embodiment of the second embodiment.

As shown in FIG. 3, DCI format 1_1 that includes two TPC fields (e.g. a first TPC field and a second TPC field) is transmitted on a downlink channel for scheduling a PUCCH transmission with 2 repetitions (corresponding to 2 PUCCH transmissions, i.e. PUCCH-1 and PUCCH-2) for one PUCCH resource activated with two different PUCCH-SpatialRelationInfos. Since the same ClosedLoopIndex l=1 is configured for the two PUCCH-SpatialRelationInfos, UE shall apply a TPC command indicated by the second TPC field (which is for PUCCH transmission(s) (or repetitions) with closed loop index l=1) to both PUCCH-1 and PUCCH-2, and ignore the first TPC field (which is for PUCCH transmission(s) (or repetitions) with closed loop index l=0).

According to a second sub-embodiment of the second embodiment, the mapping method is determined according to the scheduled PUSCH or PUCCH transmissions (repetitions).

The determination for PUCCH transmissions according to the second sub-embodiment of the second embodiment is discussed as follows.

When different ClosedLoopIndex values are indicated by the two PUCCH-SpatialRelationInfos activated for the scheduled PUCCH resource, the TPC command indicated by a first TPC field applies to the PUCCH transmission(s) with closed loop index indicated by a first activated PUCCH-SpatialRelationInfo (e.g. the first activated PUCCH-SpatialRelationInfo is identified with lower PUCCH-SpatialRelationInfold) for the scheduled PUCCH resource, and the TPC command indicated by a second TPC field applies to the PUCCH transmission(s) with the other closed loop index indicated by a second activated PUCCH-SpatialRelationInfo (e.g. identified with higher PUCCH-SpatialRelationInfold) for the scheduled PUCCH resource.

On the other hand, when a same ClosedLoopIndex value is indicated by the two PUCCH-SpatialRelationInfos activated for the scheduled PUCCH resource, or only one PUCCH-SpatialRelationInfo (which indicates only one closed loop index) is activated for the scheduled PUCCH resource, the TPC command indicated by a first TPC field applies to the scheduled PUCCH transmission(s) with the closed loop index indicated by the activated PUCCH-SpatialRelationInfo for the scheduled PUCCH resource. The TPC command indicated by a second TPC field applies to the other closed loop (i.e. the other closed loop index). Since all scheduled PUCCH transmission(s) have the same closed loop index (i.e. the closed loop index indicated by the activated PUCCH-SpatialRelationInfo for the scheduled PUCCH resource), the TPC command that applies to the other closed loop index will be ignored by the UE. In particular, the second TPC field is ignored by the UE.

An example of the second sub-embodiment of the second embodiment for PUCCH transmission can be also illustrated in FIG. 3.

The two activated PUCCH-SpatialRelationInfos for the scheduled PUCCH resource (i.e. for the scheduled PUCCH transmissions PUCCH-1 and PUCCH-2) are both configured with a same ClosedLoopIndex l=1. So, according to second sub-embodiment of the second embodiment, the TPC command indicated by the first TPC field in DCI format 1_1 applies to PUCCH transmission(s) with ClosedLoopIndex l=1. The UE should ignore the second TPC field that indicates the TPC command applying to PUCCH transmission(s) with ClosedLoopIndex l=0.

The determination for PUSCH transmissions according to the second sub-embodiment of the second embodiment is discussed as follows.

When different ClosedLoopIndex values are indicated by the sri-PUSCH-PowerControl values that are mapped to the two SRI field values included in the scheduling DCI format 0_1 or 0_2, the TPC command indicated by a first TPC field applies to the PUSCH transmission(s) with the closed loop index associated with the first SRI field, and the TPC command indicated by a second TPC field applies to the PUSCH transmission(s) with the other closed loop index associated with the second SRI field. Incidentally, sri-PUSCH-PowerControl is used to configure a set of power control parameters for PUSCH transmission using SRS resource(s) indicated by the SRI field, and each sri-PUSCH-PowerControl is mapped to a SRI field value.

On the other hand, when a same ClosedLoopIndex value is indicated by sri-PUSCH-PowerControl values that are mapped to the two SRI field values included in the scheduling DCI format 0_1 or 0_2, or only one SRS resource set is indicated for PUSCH transmission by the first SRI field included in the scheduling DCI, i.e., only one PUSCH transmission is scheduled or the scheduled PUSCH transmissions are transmitted to a same TRP, the TPC command indicated by a first TPC field applied to the scheduled PUSCH transmission(s) with the closed loop index associated with the first SRI field. The TPC command indicated by a second TPC field applies to the other closed loop (i.e. the other closed loop index). Since all scheduled PUSCH transmission(s) have the same closed loop index (i.e. the closed loop index indicated by sri-PUSCH-PowerControl values that are mapped to the SRI field values), the TPC command that applies to the other closed loop index will be ignored by the UE. In particular, and a second TPC field is ignored by the UE.

Another example of the second sub-embodiment of the second embodiment for PUSCH transmission can be also illustrated in FIG. 2.

Suppose ClosedLoopIndex l=1 is mapped to a first SRI field, and ClosedLoopIndex l=0 is mapped to a second SRI field. So, the TPC command indicated by the first TPC field in DCI format 0_1 applies to PUSCH transmissions with ClosedLoopIndex l=1 (that is the ClosedLoopIndex associated with the first SRI field), i.e. PUSCH-2 and PUSCH-4; while the TPC command indicated by the second TPC field in DCI format 0_1 applies to PUSCH transmissions with ClosedLoopIndex l=0 (that is the ClosedLoopIndex associated with the second SRI field), i.e., PUSCH-1 and PUSCH-3.

A third embodiment relates to the calculation of closed loop power adjustment.

The UE determines the closed loop power adjustment according to the equation f_{b,f,c}(i, l)=f_{b,f,c}(i−i₀, l)+ [symbol] δ_{PUSCH,b,f,c}(m, l) for PUSCH transmission or g_{b,f,c}(i, l)=g_{b,f,c}(i−i₀, l)+ [symbol] δ_{PUCCH,b,f,c}(m, l) for PUCCH transmission. δ_{PUSCH,b,f,c}(m, l) and δ_{PUCCH,b,f,c}(m, l) are the TPC command values indicated by the TPC field on active UL BWP b of carrier f of serving cell c for PUSCH and PUCCH power control adjustment state l.

Take PUSCH transmission as an example, [symbol] δ_{PUSCH,b,f,c}(m, l) is a sum of TPC command values in a set Dᵢ of TPC command values with cardinality [symbol] (Dᵢ) that the UE receives between K_{PUSCH}(i−i₀)−1 symbols before PUSCH transmission occasion i−i₀ and K_{PUSCH}(i) symbols before PUSCH transmission occasion i on active UL BWP b of carrier f of serving cell c for PUSCH power control adjustment state l, where i₀>0 is the smallest integer for which K_{PUSCH}(i−i₀) symbols before PUSCH transmission occasion i−i₀ is earlier than K_{PUSCH}(i) symbols before PUSCH transmission occasion i.

If a PUSCH transmission is scheduled by a DCI, K_{PUSCH}(i) is a number of symbols for active UL BWP b of carrier f of serving cell c after a last symbol of a corresponding PDCCH reception and before a first symbol of the PUSCH transmission.

In short, if the UE receives multiple TPC commands on the same closed loop as the scheduled PUSCH transmission between the reception of the scheduling DCI and the transmission of the scheduled PUSCH transmission, the UE shall determine the closed loop power adjustments according to the sum of all of the received multiple TPC commands.

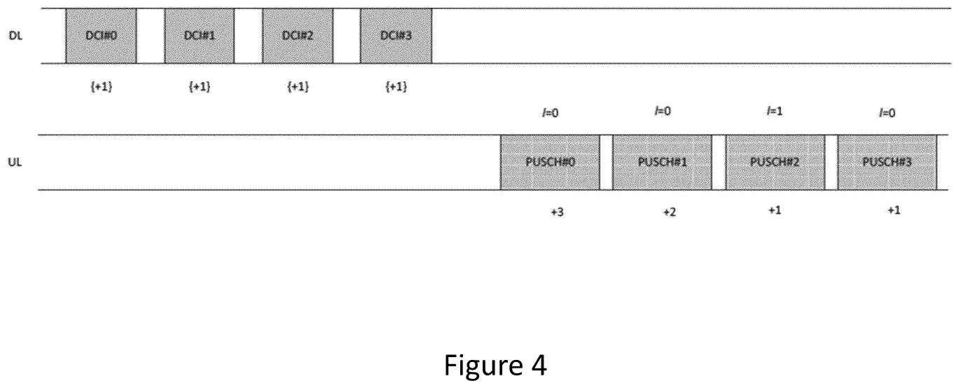

FIG. 4 illustrates a prior art example for NR Release 15 or 16 UE behavior. DCI #k (k=0, 1, 2, 3) schedules a PUSCH transmission PUSCH #k. Each DCI contains a TPC field indicating a TPC command on a closed loop for the scheduled PUSCH transmission. PUSCH #0, PUSCH #1 and PUSCH #3 are transmitted with ClosedLoopIndex l=0, while PUSCH #2 is transmitted with ClosedLoopIndex l=1. According to the prior art TPC calculation principle, the UE shall determine the closed loop power adjustment for PUSCH #0 according to the sum of the TPC commands indicated by DCI #k that schedule PUSCH transmissions transmitted with the same ClosedLoopIndex as DCI #0 and are transmitted between DCI #0 and PUSCH #0 (i.e. the TPC commands indicated by DCI #0, DCI #1 and DCI #3, while the TPC command indicated by DCI #2 is not considered since PUSCH #2 scheduled by DCI #2 is transmitted with a different ClosedLoopIndex (l=1) from the ClosedLoopIndex (l=0) for transmitting PUSCH #0), which results a power adjustment+3 dB (=+1+1+1). Similarly, the UE determines the power adjustment for PUSCH #1 according to the sum of the TPC commands included in DCI #1 and DCI #3, which results a +2 dB closed loop power adjustment (the TPC command indicated by DCI #0 is not considered since DCI #0 is not transmitted between DCI #1 and PUSCH #1, and the TPC command indicated by DCI #2 is not considered since PUSCH #2 scheduled by DCI #2 is transmitted with a different ClosedLoopIndex (l=1) from the ClosedLoopIndex (l=0) for transmitting PUSCH #1). The UE determines the power adjustment for PUSCH #2 according to the TPC command included in DCI #2, which results a +1 dB closed loop power adjustment (the TPC command indicated by DCI #0 and the TPC command indicated by DCI #1 are not considered since DCI #0 and DCI #1 are not transmitted between DCI #2 and PUSCH #2, and the TPC command indicated by DCI #3 is not considered since PUSCH #3 scheduled by DCI #3 is transmitted with a different ClosedLoopIndex (l=0) from the ClosedLoopIndex (l=1) for transmitting PUSCH #2). The UE determines the power adjustment for PUSCH #3 according to the TPC command included in DCI #3, which results a +1 dB closed loop power adjustment (the TPC commands indicated by DCI #0, DCI #1 and DCI #2 are not considered since DCI #0, DCI #1 and DCI #2 are not transmitted between DCI #3 and PUSCH #3).

According to the present invention, two TPC fields may be included in the DCI according to RRC configuration. It means that two TPC commands regarding to different power control loops may be indicated by one DCI.

However, as discussed in the first embodiment and the second embodiment, the gNB may schedule a single PUSCH transmission to a single TRP by using a DCI containing two TPC fields. The UE shall ignore one TPC command in this scenario.

According to a first sub-embodiment of the third embodiment, the ignored TPC command(s) are not included in the calculation of the sum of the TPC commands, that is, the ignored TPC command(s) are not considered in the calculation of the closed loop power adjustment.

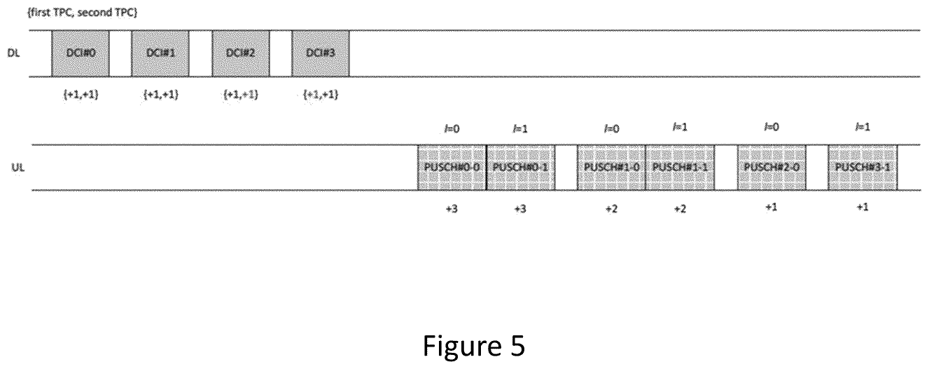

FIG. 5 illustrates an example of the first sub-embodiment of the third embodiment.

Each DCI schedules one or more (e.g. two) PUSCH transmissions. As shown in FIG. 5, PUSCH #0-0 and PUSCH #0-1 are scheduled by DCI #0; PUSCH #1-0 and PUSCH #1-1 are scheduled by DCI #1; PUSCH #2-0 is scheduled by DCI #2, and PUSCH #3-1 is scheduled by DCI #3. Each DCI contains two TPC fields. Suppose that the first sub-embodiment of the second embodiment is adopted. That is, the TPC command indicated by a first TPC field applies to closed loop index l=0; and the TPC command indicated by a second TPC field applies to closed loop index l=1. The closed loop index value l for each PUSCH transmission is shown in FIG. 5. That is, PUSCH #0-0: l=0; PUSCH #0-1: l=1; PUSCH #1-0: l=0; PUSCH #1-1: l=1; PUSCH #2-0: l=0; and PUSCH #3-1: l=1. Therefore, according to the first sub-embodiment of the second embodiment: the second TPC field of DCI #2 and the first TPC field of DCI #3 are ignored by the UE.

According to the first sub-embodiment of the third embodiment, the closed loop power adjustment for PUSCH #0-0 is the sum of TPC commands indicated by DCI #0, DCI #1, DCI #2 and DCI #3 for ClosedLoopIndex l=0 excluding the ignored TPC command (i.e., TPC command indicated by the first TPC field of DCI #3), which results a closed loop power adjustment (+1)+(+1)+(+1)=+3 dB.

The power adjustment for PUSCH #0-1 is the sum of TPC commands indicated by DCI #0, DCI #1, DCI #2 and DCI #3 for ClosedLoopIndex l=1 excluding the ignored TPC command (i.e., TPC command indicated by the second TPC field of DCI #2), which results a closed loop power adjustment (+1)+(+1)+(+1)=+3 dB.

The power adjustment for PUSCH #1-0 is the sum of TPC commands indicated by DCI #1, DCI #2 and DCI #3 for ClosedLoopIndex l=0 excluding the ignored TPC command (i.e., TPC command indicated by the first TPC field of DCI #3), which results a closed loop power adjustment (+1)+(+1)=+2 dB.

The power adjustment for PUSCH #1-1 is the sum of TPC commands indicated by DCI #1, DCI #2 and DCI #3 for ClosedLoopIndex l=1 excluding the ignored TPC command (i.e., TPC command indicated by the second TPC field of DCI #2), which results a closed loop power adjustment (+1)+(+1)=+2 dB.

The power adjustment for PUSCH #2-0 is the sum of TPC commands indicated by DCI #2 and DCI #3 for ClosedLoopIndex l=0 excluding the ignored TPC command (i.e., TPC command indicated by the first TPC field of DCI #3), which results a closed loop power adjustment+1 dB.

The power adjustment for PUSCH #3-1 is the TPC command indicated by DCI #3 for ClosedLoopIndex l=1, which results a closed loop power adjustment+1 dB.

According to a second sub-embodiment of the third embodiment, the ignored TPC command(s) are still included in the calculation of the sum of the TPC commands, that is, the ignored TPC command(s) are also considered in the calculation of the closed loop power adjustment.

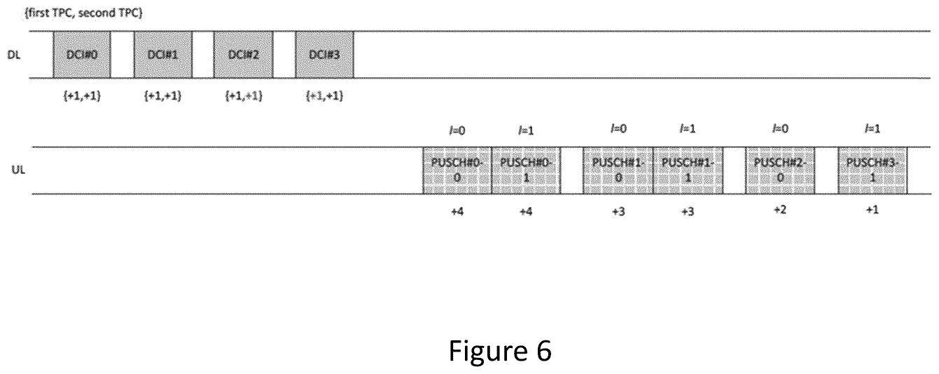

FIG. 6 illustrates an example of the second sub-embodiment of the third embodiment.

Each DCI schedules one or more (e.g. two) PUSCH transmissions. The scheduling of PUSCH transmissions by DCI shown in FIG. 6 is completely the same as FIG. 5. Different from the example shown in FIG. 5, the closed loop power adjustment of each PUSCH transmission also takes the ignored TPC command(s) into consideration. In particular, the TPC commands indicated by the ignored TPC fields (e.g. the second TPC field of DCI #2 and the first TPC field of DCI #3) are included for the calculation of the closed loop power adjustment.

According to the second sub-embodiment of the third embodiment, the closed loop power adjustment for PUSCH #0-0 is the sum of TPC commands indicated by DCI #0, DCI #1, DCI #2 and DCI #3 for ClosedLoopIndex l=0, which results a closed loop power adjustment (+1)+(+1)+(+1)+(+1)=+4 dB.

The power adjustment for PUSCH #0-1 is the sum of TPC commands indicated by DCI #0, DCI #1, DCI #2 and DCI #3 for ClosedLoopIndex l=1, which results a closed loop power adjustment (+1)+(+1)+(+1)+(+1)=+4 dB.

The power adjustment for PUSCH #1-0 is the sum of TPC commands indicated by DCI #1, DCI #2 and DCI #3 for ClosedLoopIndex l=0, which results a closed loop power adjustment (+1)+(+1)+(+1)=+3 dB.

The power adjustment for PUSCH #1-1 is the sum of TPC commands indicated by DCI #1, DCI #2 and DCI #3 for ClosedLoopIndex l=1, which results a closed loop power adjustment (+1)+(+1)+(+1)=+3 dB.

The power adjustment for PUSCH #2-0 is the sum of TPC commands indicated by DCI #2 and DCI #3 for ClosedLoopIndex l=0, which results a closed loop power adjustment (+1)+(+1)=+2 dB.

The power adjustment for PUSCH #3-1 is the TPC command indicated by DCI #3 for ClosedLoopIndex l=1, which results a closed loop power adjustment+1 dB.

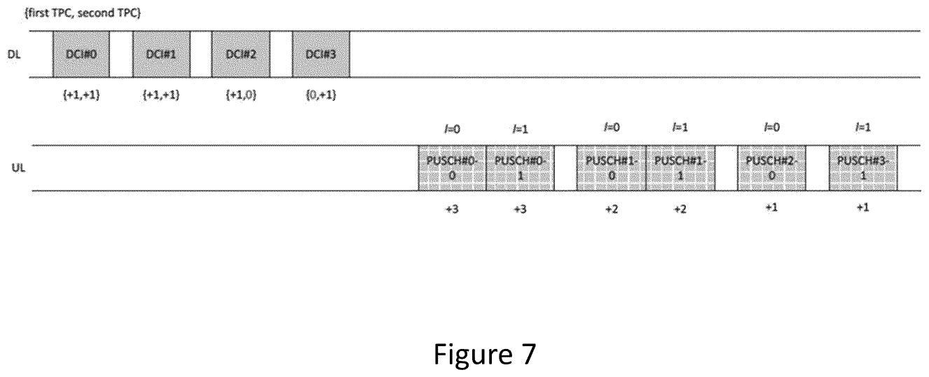

FIG. 7 illustrates another example of the second sub-embodiment of the third embodiment.

As shown in FIG. 7, the gNB indicates a 0 dB TPC command in the ignored TPC field (e.g. the second TPC field of DCI #2 and the first TPC field of DCI #3). In this manner, the same closed loop power adjustment as the example of FIG. 5 can be achieved if the ignored TPC fields are also considered in the calculation of the closed loop power adjustments.

According to the second sub-embodiment of the third embodiment, in the example of FIG. 7, the closed loop power adjustment for PUSCH #0-0 is the sum of TPC commands indicated by DCI #0, DCI #1, DCI #2 and DCI #3 for ClosedLoopIndex l=0, which results a closed loop power adjustment (+1)+(+1)+(+1)+(0)=+3 dB.

The power adjustment for PUSCH #0-1 is the sum of TPC commands indicated by DCI #0, DCI #1, DCI #2 and DCI #3 for ClosedLoopIndex l=1, which results a closed loop power adjustment (+1)+(+1)+(0)+(+1)=+3 dB.

The power adjustment for PUSCH #1-0 is the sum of TPC commands indicated by DCI #1, DCI #2 and DCI #3 for ClosedLoopIndex l=0, which results a closed loop power adjustment (+1)+(+1)+(0)=+2 dB.

The power adjustment for PUSCH #1-1 is the sum of TPC commands indicated by DCI #1, DCI #2 and DCI #3 for ClosedLoopIndex l=1, which results a closed loop power adjustment (+1)+(0)+(+1)=+2 dB.

The power adjustment for PUSCH #2-0 is the sum of TPC commands indicated by DCI #2 and DCI #3 for ClosedLoopIndex l=0, which results a closed loop power adjustment (+1)+(0)=+1 dB.

The power adjustment for PUSCH #3-1 is the TPC command indicated by DCI #3 for ClosedLoopIndex l=1, which results a closed loop power adjustment+1 dB.

Accordingly, the second sub-embodiment of the third embodiment provides the flexibility to the gNB to have one more opportunity to adjust the power of a certain closed loop.

Similar principle can be applied to the calculation of closed loop power adjustment for PUCCH transmission, i.e., the TPC commands corresponding to the ignored TPC field shall not be included in the calculation of the sum of TPC commands between the corresponding PDCCH reception and the PUCCH transmission, according to the first sub-embodiment of the third embodiment. Alternatively, the ignored TPC field is included in the calculation of the sum of TPC commands between the corresponding PDCCH reception and the PUCCH transmission to provide additional opportunity to adjust the power of a certain closed loop, according to the second sub-embodiment of the third embodiment.

A fourth embodiment relates to transmitting the scheduled PUSCH or PUCCH transmissions. When the closed loop power adjustment for each of the scheduled PUSCH or PUCCH transmissions has been calculated, the UE transmits each of the scheduled PUSCH or PUCCH transmissions with a power based on its calculated closed loop power adjustment. In particular, the calculated closed loop power adjustment will be added to the power determined by the open loop power control parameters and PUSCH or PUCCH transmission parameters including band width and code rate to obtain the power used to transmit each of the scheduled PUSCH or PUCCH transmissions.

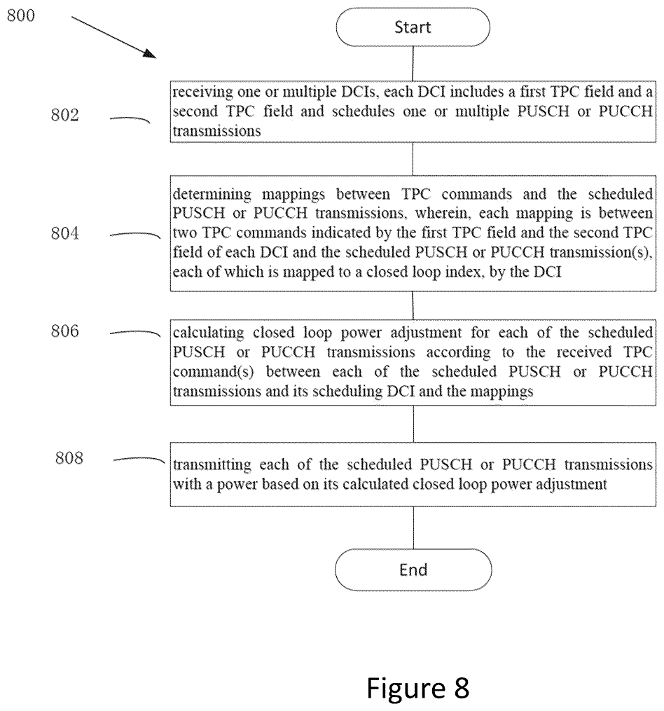

FIG. 8 is a schematic flow chart diagram illustrating an embodiment of a method 800 according to the present application. In some embodiments, the method 800 is performed by an apparatus, such as a remote unit (UE). In certain embodiments, the method 800 may be performed by a processor executing program code, for example, a microcontroller, a microprocessor, a CPU, a GPU, an auxiliary processing unit, a FPGA, or the like.

The method 800 may include 802 receiving one or multiple DCIs, each DCI includes a first TPC field and a second TPC field and schedules one or multiple PUSCH or PUCCH transmissions; 804 determining mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI; 806 calculating closed loop power adjustment for each of the scheduled PUSCH or PUCCH transmissions according to the received TPC command(s) between each of the scheduled PUSCH or PUCCH transmissions and its scheduling DCI and the mappings; and 808 transmitting each of the scheduled PUSCH or PUCCH transmissions with a power based on its calculated closed loop power adjustment. The method may further comprise receiving a RRC signaling to configure that the second TPC field is included in the DCI format 0_1 or 0_2, when two SRS resource sets, both of which are used for either codebook or non-codebook, are configured in a BWP and two PUSCH power control adjustment states are configured and the UE indicates a capability to support two TPC fields in DCI format 0_1 or 0_2 for scheduling PUSCH transmissions, and/or receiving a RRC signaling to configure that the second TCP field is indicated in the DCI format 1_1 or 1_2, when at least one PUCCH resource is activated with more than one PUCCH-SpatialRelationInfo and two PUCCH power control adjustment states are configured and the UE indicates a capability to support two TPC fields in DCI format 1_1 or 1_2 for scheduling PUCCH transmissions.

In one embodiment, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1. If only one PUCCH-SpatialRelationInfo is activated for the scheduled PUCCH transmission or a same closed loop index is indicated by the two PUCCH-SpatialRelationInfos activated for the scheduled PUCCH transmissions, or if only one PUSCH transmission is scheduled or the scheduled multiple PUSCH transmissions are indicated with a same closed loop index, the TPC command indicated by one of the first TPC field and the second TPC field that has the same closed loop index as that indicated to the scheduled PUCCH or PUSCH transmission(s) is applied to the scheduled PUCCH or PUSCH transmission(s), and the TPC command indicated by the other of the first TPC field and the second TPC field is ignored.

In another embodiment, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo. When a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmission(s) with the ClosedLoopIndex value indicated by the PUCCH-SpatialRelationInfo(s) activated for the PUCCH transmissions, and the TPC command indicated by the second TPC field is ignored. When different ClosedLoopIndex values are indicated by the sri-PUSCH-PowerControl values that are mapped to values of a first SRI field and a second SRI field included in a DCI format 0_1 or 0_2, the TPC command indicated by the first TPC field of the DCI applies to the PUSCH transmission(s) with the ClosedLoopIndex value indicated by the first SRI field, and the TPC command indicated by the second TPC field applies to the PUSCH transmission(s) with the ClosedLoopIndex value indicated by the second SRI field. When a same ClosedLoopIndex value is indicated by sri-PUSCH-PowerControl values that are mapped to values of a first SRI field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

In some embodiment, the ignored TPC command(s) are not included in calculating the closed loop power adjustment. Alternatively, the ignored TPC command(s) are included in calculating the closed loop power adjustment.

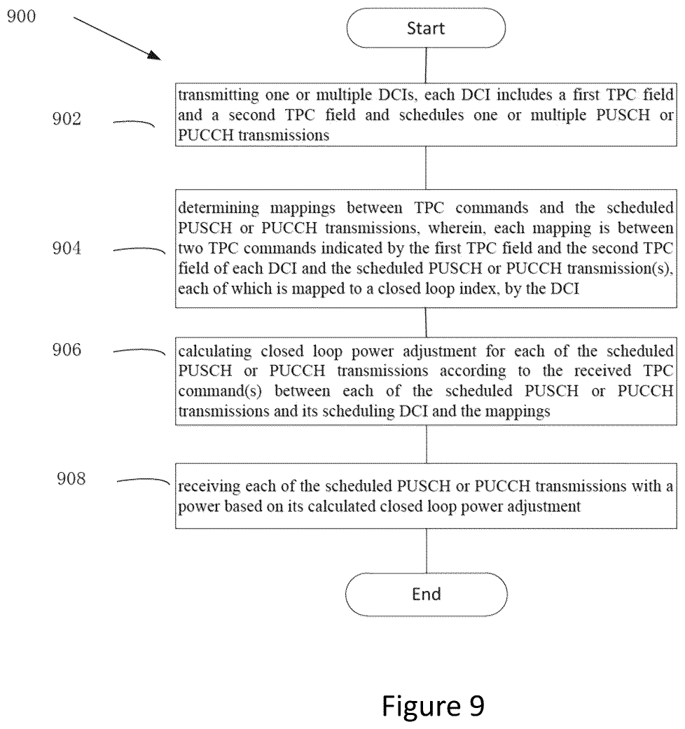

FIG. 9 is a schematic flow chart diagram illustrating a further embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may include 902 transmitting one or multiple DCIs, each DCI includes a first TPC field and a second TPC field and schedules one or multiple PUSCH or PUCCH transmissions; 904 determining mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI; 906 calculating closed loop power adjustment for each of the scheduled PUSCH or PUCCH transmissions according to the received TPC command(s) between each of the scheduled PUSCH or PUCCH transmissions and its scheduling DCI and the mappings; and 908 receiving each of the scheduled PUSCH or PUCCH transmissions with a power based on its calculated closed loop power adjustment. The method may further comprise transmitting a RRC signaling to configure that the second TPC field is included in the DCI format 0_1 or 0_2, when two SRS resource sets, both of which are used for either codebook or non-codebook, are configured in a BWP and two PUSCH power control adjustment states are configured and the UE indicates a capability to support two TPC fields in DCI format 0_1 or 0_2 for scheduling PUSCH transmissions, and/or transmitting a RRC signaling to configure that the second TCP field is indicated in the DCI format 1_1 or 1_2, when at least one PUCCH resource is activated with more than one PUCCH-SpatialRelationInfo and two PUCCH power control adjustment states are configured and the UE indicates a capability to support two TPC fields in DCI format 1_1 or 1_2 for scheduling PUCCH transmissions.

In one embodiment, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1. If only one PUCCH-SpatialRelationInfo is activated for the scheduled PUCCH transmission or a same closed loop index is indicated by the two PUCCH-SpatialRelationInfos activated for the scheduled PUCCH transmissions, or if only one PUSCH transmission is scheduled or the scheduled multiple PUSCH transmissions are indicated with a same closed loop index, the TPC command indicated by one of the first TPC field and the second TPC field that has the same closed loop index as that indicated to the scheduled PUCCH or PUSCH transmission(s) is applied to the scheduled PUCCH or PUSCH transmission(s), and the TPC command indicated by the other of the first TPC field and the second TPC field is ignored.

In another embodiment, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo. When a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmission(s) with the ClosedLoopIndex value indicated by the PUCCH-SpatialRelationInfo(s) activated for the PUCCH transmissions, and the TPC command indicated by the second TPC field is ignored. When different ClosedLoopIndex values are indicated by the sri-PUSCH-PowerControl values that are mapped to values of a first SRI field and a second SRI field included in a DCI format 0_1 or 0_2, the TPC command indicated by the first TPC field of the DCI applies to the PUSCH transmission(s) with the ClosedLoopIndex value indicated by the first SRI field, and the TPC command indicated by the second TPC field applies to the PUSCH transmission(s) with the ClosedLoopIndex value indicated by the second SRI field. When a same ClosedLoopIndex value is indicated by sri-PUSCH-PowerControl values that are mapped to values of a first SRI field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

In some embodiment, the ignored TPC command(s) are not included in calculating the closed loop power adjustment. Alternatively, the ignored TPC command(s) are included in calculating the closed loop power adjustment.

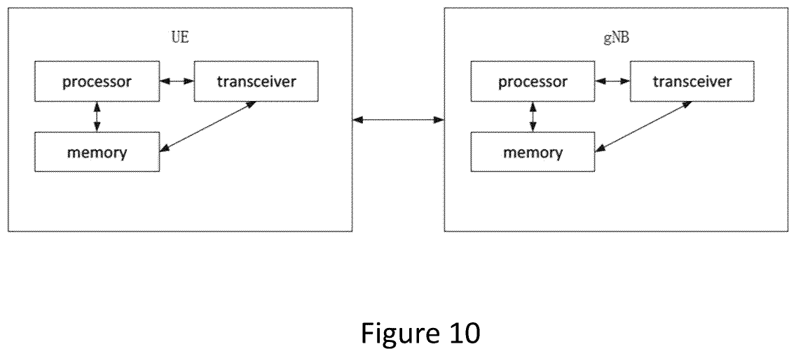

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 8.

The UE comprises a receiver that receives one or multiple DCIs, each DCI includes a first TPC field and a second TPC field and schedules one or multiple PUSCH or PUCCH transmissions; a processor that determines mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI, and calculates closed loop power adjustment for each of the scheduled PUSCH or PUCCH transmissions according to the received TPC command(s) between each of the scheduled PUSCH or PUCCH transmissions and its scheduling DCI and the mappings; and a transmitter that transmits each of the scheduled PUSCH or PUCCH transmissions with a power based on its calculated closed loop power adjustment. The receiver may further receive a RRC signaling to configure that the second TPC field is included in the DCI format 0_1 or 0_2, when two SRS resource sets, both of which are used for either codebook or non-codebook, are configured in a BWP and two PUSCH power control adjustment states are configured and the UE indicates a capability to support two TPC fields in DCI format 0_1 or 0_2 for scheduling PUSCH transmissions, and/or a RRC signaling to configure that the second TCP field is indicated in the DCI format 1_1 or 1_2, when at least one PUCCH resource is activated with more than one PUCCH-SpatialRelationInfo and two PUCCH power control adjustment states are configured and the UE indicates a capability to support two TPC fields in DCI format 1_1 or 1_2 for scheduling PUCCH transmissions.

In one embodiment, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1. If only one PUCCH-SpatialRelationInfo is activated for the scheduled PUCCH transmission or a same closed loop index is indicated by the two PUCCH-SpatialRelationInfos activated for the scheduled PUCCH transmissions, or if only one PUSCH transmission is scheduled or the scheduled multiple PUSCH transmissions are indicated with a same closed loop index, the TPC command indicated by one of the first TPC field and the second TPC field that has the same closed loop index as that indicated to the scheduled PUCCH or PUSCH transmission(s) is applied to the scheduled PUCCH or PUSCH transmission(s), and the TPC command indicated by the other of the first TPC field and the second TPC field is ignored.

In another embodiment, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo. When a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmission(s) with the ClosedLoopIndex value indicated by the PUCCH-SpatialRelationInfo(s) activated for the PUCCH transmissions, and the TPC command indicated by the second TPC field is ignored. When different ClosedLoopIndex values are indicated by the sri-PUSCH-PowerControl values that are mapped to values of a first SRI field and a second SRI field included in a DCI format 0_1 or 0_2, the TPC command indicated by the first TPC field of the DCI applies to the PUSCH transmission(s) with the ClosedLoopIndex value indicated by the first SRI field, and the TPC command indicated by the second TPC field applies to the PUSCH transmission(s) with the ClosedLoopIndex value indicated by the second SRI field. When a same ClosedLoopIndex value is indicated by sri-PUSCH-PowerControl values that are mapped to values of a first SRI field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

In some embodiment, the ignored TPC command(s) are not included in calculating the closed loop power adjustment. Alternatively, the ignored TPC command(s) are included in calculating the closed loop power adjustment.

Referring to FIG. 10, the gNB (i.e. base unit) includes a processor, a memory, and a transceiver. The processors implement a function, a process, and/or a method which are proposed in FIG. 9.

The base unit comprises a transmitter that transmits one or multiple DCIs, each DCI includes a first TPC field and a second TPC field and schedules one or multiple PUSCH or PUCCH transmissions; a processor that determines mappings between TPC commands and the scheduled PUSCH or PUCCH transmissions, wherein, each mapping is between two TPC commands indicated by the first TPC field and the second TPC field of each DCI and the scheduled PUSCH or PUCCH transmission(s), each of which is mapped to a closed loop index, by the DCI, and calculates closed loop power adjustment for each of the scheduled PUSCH or PUCCH transmissions according to the received TPC command(s) between each of the scheduled PUSCH or PUCCH transmissions and its scheduling DCI and the mappings; and a receiver that receives each of the scheduled PUSCH or PUCCH transmissions with a power based on its calculated closed loop power adjustment. The transmitter may further transmit a RRC signaling to configure that the second TPC field is included in the DCI format 0_1 or 0_2, when two SRS resource sets, both of which are used for either codebook or non-codebook, are configured in a BWP and two PUSCH power control adjustment states are configured and the UE indicates a capability to support two TPC fields in DCI format 0_1 or 0_2 for scheduling PUSCH transmissions, and/or a RRC signaling to configure that the second TCP field is indicated in the DCI format 1_1 or 1_2, when at least one PUCCH resource is activated with more than one PUCCH-SpatialRelationInfo and two PUCCH power control adjustment states are configured and the UE indicates a capability to support two TPC fields in DCI format 1_1 or 1_2 for scheduling PUCCH transmissions.

In one embodiment, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1. If only one PUCCH-SpatialRelationInfo is activated for the scheduled PUCCH transmission or a same closed loop index is indicated by the two PUCCH-SpatialRelationInfos activated for the scheduled PUCCH transmissions, or if only one PUSCH transmission is scheduled or the scheduled multiple PUSCH transmissions are indicated with a same closed loop index, the TPC command indicated by one of the first TPC field and the second TPC field that has the same closed loop index as that indicated to the scheduled PUCCH or PUSCH transmission(s) is applied to the scheduled PUCCH or PUSCH transmission(s), and the TPC command indicated by the other of the first TPC field and the second TPC field is ignored.

In another embodiment, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo. When a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmission(s) with the ClosedLoopIndex value indicated by the PUCCH-SpatialRelationInfo(s) activated for the PUCCH transmissions, and the TPC command indicated by the second TPC field is ignored. When different ClosedLoopIndex values are indicated by the sri-PUSCH-PowerControl values that are mapped to values of a first SRI field and a second SRI field included in a DCI format 0_1 or 0_2, the TPC command indicated by the first TPC field of the DCI applies to the PUSCH transmission(s) with the ClosedLoopIndex value indicated by the first SRI field, and the TPC command indicated by the second TPC field applies to the PUSCH transmission(s) with the ClosedLoopIndex value indicated by the second SRI field. When a same ClosedLoopIndex value is indicated by sri-PUSCH-PowerControl values that are mapped to values of a first SRI field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

In some embodiment, the ignored TPC command(s) are not included in calculating the closed loop power adjustment. Alternatively, the ignored TPC command(s) are included in calculating the closed loop power adjustment.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1-13. (canceled)

14. A User Equipment (UE), comprising:
a processor; and
a memory coupled with the processor, the processor configured to cause the UE to:
receive a Radio Resource Control (RRC) signaling that configures a second Transmission Power Command (TPC) field in a Downlink Control Information (DCI) format 0_1 or 0_2 when two sounding reference signal (SRS) resource sets, both of which are used for either codebook or non-codebook, are configured in a Bandwidth Partition (BWP) and two Physical Uplink Shared Channel (PUSCH) power control adjustment states are configured; or
receiving an RRC signaling that configures the second TPC field in a DCI format 1_1 or 1_2, when a Physical Uplink Control Channel (PUCCH) repetition is configured and two PUCCH power control adjustment states are configured and the UE indicates a capability to support two TPC fields in DCI format 1_1 or 1_2 for scheduling PUCCH transmissions.

15. The UE of claim 14, wherein the processor is further configured to cause the UE to:
receive one or multiple DCIs,
wherein each DCI includes a first TPC field and the second TPC field and schedules one or multiple PUSCH or PUCCH transmissions;
determine mappings between TPC commands and the scheduled PUSCH or PUCCH transmissions,
wherein each mapping is between two TPC commands indicated by the first TPC field and the second TPC field of each DCI and the scheduled PUSCH or PUCCH transmissions, each of which is mapped to a closed loop index by the DCI;
calculate closed loop power adjustment for each of the scheduled PUSCH or PUCCH transmissions according to the received TPC commands between each of the scheduled PUSCH or PUCCH transmissions; and
transmit each of the scheduled PUSCH or PUCCH transmissions with a power based on the calculated closed loop power adjustment.

16. The UE of claim 15, wherein, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1.

17. The UE of claim 15, wherein, when: (1) only one PUCCH-SpatialRelationInfo is activated for the scheduled PUCCH transmission, (2) a same closed loop index is indicated by two PUCCH-SpatialRelationInfos activated for the scheduled PUCCH transmissions, (3) only one PUSCH transmission is scheduled or, (4) the scheduled multiple PUSCH transmissions are indicated with a same closed loop index, the TPC command indicated the first TPC field or the second TPC field that has the same closed loop index as that indicated to the scheduled PUCCH or PUSCH transmissions is applied to the scheduled PUCCH or PUSCH transmissions and the TPC command indicated by the other TPC field of the first TPC field or the second TPC field is ignored.

18. The UE of claim 17, wherein the ignored TPC command(s) are not included in calculating the closed loop power adjustment.

19. The UE of claim 17, wherein the ignored TPC command(s) are included in calculating the closed loop power adjustment.

20. The UE of claim 15, wherein, when different ClosedLoopIndex values are indicated by two PUCCH-SpatialRelationInfos activated for the scheduled PUCCH transmissions, the TPC command indicated by the first TPC field applies to the PUCCH transmissions with the ClosedLoopIndex value indicated by a first PUCCH-SpatialRelationInfo, and the TPC command indicated by the second TPC field applies to the PUCCH transmissions with the ClosedLoopIndex value indicated by a second PUCCH-SpatialRelationInfo.

21. The UE of claim 15, wherein, when a same ClosedLoopIndex value is indicated by two PUCCH-SpatialRelationInfos activated for the scheduled PUCCH transmissions, or only one PUCCH-SpatialRelationInfo is activated for the scheduled PUCCH transmissions, the TPC command indicated by the first TPC field applies to the PUCCH transmissions) with the ClosedLoopIndex value indicated by the PUCCH-SpatialRelationInfo(s) activated for the PUCCH transmissions, and the TPC command indicated by the second TPC field is ignored.

22. The UE of claim 15, wherein, when different ClosedLoopIndex values are indicated by sri-PUSCH-PowerControl values that are mapped to values of a first sounding reference signal (SRS) resource indicator (SRI) field and a second SRI field included in a DCI format 0_1 or 0_2, the TPC command indicated by the first TPC field of the DCI applies to the PUSCH transmission with the ClosedLoopIndex value indicated by the first SRI field, and the TPC command indicated by the second TPC field applies to the PUSCH transmission(s) with the ClosedLoopIndex value indicated by the second SRI field.

23. The UE of claim 15, wherein, when a same ClosedLoopIndex value is indicated by sri-PUSCH-PowerControl values that are mapped to values of a first sounding reference signal (SRS) resource indicator (SRI) field and a second SRI field included in the DCI format 0_1 or 0_2, or only one SRS resource set indicated by the first SRI field is used for the PUSCH transmission, the TPC command indicated by the first TPC field applies to the PUSCH transmission(s) with the ClosedLoopIndex value indicated by the first SRI field, and the TPC command indicated by the second TPC field is ignored.

24. A processor for wireless communication, comprising:
at least one controller coupled with at least one memory and configured to cause the processor to:
receive a Radio Resource Control (RRC) signaling that configures a second Transmission Power Command (TPC) field in a Downlink Control Information (DCI) format 0_1 or 0_2 when two sounding reference signal (SRS) resource sets, both of which are used for either codebook or non-codebook, are configured in a Bandwidth Partition (BWP) and two Physical Uplink Shared Channel (PUSCH) power control adjustment states are configured; or
receiving an RRC signaling that configures the second TPC field in a DCI format 1_1 or 1_2, when a Physical Uplink Control Channel (PUCCH) repetition is configured and two PUCCH power control adjustment states are configured and the UE indicates a capability to support two TPC fields in DCI format 1_1 or 1_2 for scheduling PUCCH transmissions.

25. The processor of claim 24, wherein the processor is further configured to cause the UE to:
receive one or multiple DCIs,
wherein each DCI includes a first TPC field and the second TPC field and schedules one or multiple PUSCH or PUCCH transmissions;
determine mappings between TPC commands and the scheduled PUSCH or PUCCH transmissions,
wherein each mapping is between two TPC commands indicated by the first TPC field and the second TPC field of each DCI and the scheduled PUSCH or PUCCH transmissions, each of which is mapped to a closed loop index by the DCI;
calculate closed loop power adjustment for each of the scheduled PUSCH or PUCCH transmissions according to the received TPC commands between each of the scheduled PUSCH or PUCCH transmissions; and
transmit each of the scheduled PUSCH or PUCCH transmissions with a power based on the calculated closed loop power adjustment.

26. The processor of claim 25, wherein, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1.

27. A method performed by a User Equipment (UE), the method comprising:
receiving a Radio Resource Control (RRC) signaling that configures a second Transmission Power Command (TPC) field in a Downlink Control Information (DCI) format 0_1 or 0_2 when two sounding reference signal (SRS) resource sets, both of which are used for either codebook or non-codebook, are configured in a Bandwidth Partition (BWP) and two Physical Uplink Shared Channel (PUSCH) power control adjustment states are configured; or
receiving an RRC signaling that configures the second TPC field in a DCI format 1_1 or 1_2, when a Physical Uplink Control Channel (PUCCH) repetition is configured and two PUCCH power control adjustment states are configured and the UE indicates a capability to support two TPC fields in DCI format 1_1 or 1_2 for scheduling PUCCH transmissions.

28. The method of claim 27, further comprising:
receiving one or multiple DCIs,
wherein each DCI includes a first TPC field and the second TPC field and schedules one or multiple PUSCH or PUCCH transmissions;
determining mappings between TPC commands and the scheduled PUSCH or PUCCH transmissions,
wherein each mapping is between two TPC commands indicated by the first TPC field and the second TPC field of each DCI and the scheduled PUSCH or PUCCH transmissions, each of which is mapped to a closed loop index by the DCI;
calculating closed loop power adjustment for each of the scheduled PUSCH or PUCCH transmissions according to the received TPC commands between each of the scheduled PUSCH or PUCCH transmissions; and
transmitting each of the scheduled PUSCH or PUCCH transmissions with a power based on the calculated closed loop power adjustment.

29. The method of claim 28, wherein, the TPC command indicated by the first TPC field of a DCI applies to each of the PUSCH or PUCCH transmissions scheduled by the DCI with ClosedLoopIndex l=0, and the TPC command indicated by the second TPC field of the DCI applies to each of the PUSCH or PUCCH transmissions scheduled by the DCI with ClosedLoopIndex l=1.

30. The method of claim 28, wherein, when: (1) only one PUCCH-SpatialRelationInfo is activated for the scheduled PUCCH transmission, (2) a same closed loop index is indicated by two PUCCH-SpatialRelationInfos activated for the scheduled PUCCH transmissions, (3) only one PUSCH transmission is scheduled or, (4) the scheduled multiple PUSCH transmissions are indicated with a same closed loop index, the TPC command indicated the first TPC field or the second TPC field that has the same closed loop index as that indicated to the scheduled PUCCH or PUSCH transmissions is applied to the scheduled PUCCH or PUSCH transmissions and the TPC command indicated by the other TPC field of the first TPC field or the second TPC field is ignored.

31. The method of claim 28, wherein the ignored TPC command(s) are not included in calculating the closed loop power adjustment.

32. The method of claim 28, wherein the ignored TPC command(s) are included in calculating the closed loop power adjustment.

33. A base unit, comprising:
a processor; and
a memory coupled with the processor, the processor configured to cause the base unit to:
transmit one or multiple Downlink Control Information (DCIs),
wherein each DCI includes a first Transmission Power Command (TPC) field and a second TPC field and schedules one or multiple Physical Uplink Shared Channel (PUSCH) or Physical Uplink Control Channel (PUCCH) transmissions; and
determine mappings between TPC commands and the scheduled PUSCH or PUCCH transmissions,
wherein each mapping is between two TPC commands indicated by the first TPC field and the second TPC field of each DCI and the scheduled PUSCH or PUCCH transmission(s), each of which is mapped to a closed loop index, by the DCI;
calculate closed loop power adjustment for each of the scheduled PUSCH or PUCCH transmissions according to the received TPC commands between each of the scheduled PUSCH or PUCCH transmissions; and
receive each of the scheduled PUSCH or PUCCH transmissions with a power based on the calculated closed loop power adjustment.
